(19) United States
(12) Patent Application Publication
(10) Pub. No.: US 2015/0176714 A1
(43) Pub. Date: Jun. 25, 2015

(54) GAS VALVE

(71) Applicant: Robert Bosch GmbH, Stuttgart (DE)

(72) Inventors: Roland Mitter, Gramastetten (AT); Hebert Lederhilger, Linz (AT); Arthur Eberhart, Kirchdorf an der Krems (AT)

(21) Appl. No.: 14/578,498

(22) Filed: Dec. 22, 2014

(30) Foreign Application Priority Data
Dec. 20, 2013 (DE) 10 2013 226 912.9

(51) Int. Cl. F16K 11/04

(52) U.S. Cl. CPC F16K 11/04

(57) ABSTRACT

Gas valve for the fuel supply of heat engines, with a housing (1) and with a valve plate (5) in which are formed flow holes (22) for the passage of the gas flow which is to be controlled. A valve head (9) is arranged in a longitudinally movable manner in the gas valve and interacts with the valve plate (5) for opening and closing the flow holes (22), wherein holes (20) for the gas flow which is to be controlled are formed in the valve head (9) and wherein the flow holes (22) in the valve plate (5) have a circular cross section.

### BACKGROUND OF THE INVENTION

The invention relates to a gas valve as is used for the fuel supply of heat engines.

Heat engines, which are operated with gaseous fuels, require injection valves or metering valves for the metering of the gas, which inject the amount of gas required for each working cycle into the inflow of the air or, if necessary, even introduce said amount of gas directly into the combustion space. Such engines are frequently used as stationary engines which serve for power generation. The valves in this case can be used separately for each individual cylinder or used in a central injection unit for a plurality of, or all of, the engine cylinders. Such a gas valve is known from document U.S. Pat. No. 6,182,943 B1, for example.

The gas valves have the task of opening a corresponding valve cross section in the time available and for feeding the gas required for injection under an inflow pressure into the induction tract in which a certain induction pressure prevails. The pressure difference is positive in this case, i.e. the inflow pressure of the gas is higher than the pressure in the induction tract so that with the gas valve open the gas flows into the induction tract without further measures. The amount of injected gas, however, depends in the main on the pressure difference and opening duration of the valve. For controlling the injected amount of gas, the actuated duration of the gas valve is varied in this case mostly by the corresponding energizing of the usually electromagnetic actuator. A homogeneous fuel-air mixture in the cylinder is important in this case for the operation of the heat engines. Since the engines are frequently operated in extremely lean mode, the requirements for the mixture forming are high in order to achieve a uniform combustion and the optimum flame velocity. The homogenous mixture forming of the gaseous fuel with the air is frequently carried out by controlling the flow en route to the combustion space.

In the case of the currently known valves, use is made of flat seats which open one or more gaps formed by rings. These rings are held together via ribs. As a result, rigidity jumps over the radius and irregular levels of rigidity of valve plate and valve head over the circumference are created, which can lead to leakages of the valve in the closed state. The avoidance of these irregularities in rigidity by varying the shape and number of the ribs is costly and makes the gas valve and consequently the power generated by the heat engine more expensive.

### SUMMARY OF THE INVENTION

The gas valve according to the invention for the fuel supply of heat engines in contrast has the advantage that it has high mechanical stability and therefore good sealing with low production costs at the same time. To this end, the gas valve for the fuel supply of the heat engine has a valve plate in which are formed flow holes for passage of the gas flow which is to be controlled. A valve head is arranged in a longitudinally movable manner in the gas valve in this case and interacts with the valve plate for opening and closing the flow holes, wherein holes are formed in the valve head for the gas flow which is to be controlled. The flow holes of the valve plate are formed as holes with a circular cross section.

By the forming of the holes instead of ribs with slots, formed in between, for passage of the gas, the valve plate can be produced in a very stable manner. Via the number and size of the holes, the flow cross section can be easily varied and therefore a large flow cross section can be quickly selected. The holes furthermore have the advantage that a very homogeneous distribution of the gas downstream of the gas valve is carried out, which is favorable for optimum combustion in the combustion space of the corresponding heat engine.

In a first advantageous embodiment of the invention, the valve plate is at least in the main of disk-like design and has an upper and a lower end face which are orientated parallel to each other. The flow holes are orientated perpendicularly to the end face of the valve plate, wherein the valve plate is advantageously clamped in a fixed manner inside the housing of the gas valve. As a result of this arrangement of the holes in the valve plate, the maximum number of holes can be accommodated with optimized stability at the same time.

In a further advantageous embodiment, the holes in the valve head are also formed as holes with a circular cross section. In this case, the holes of the valve head and of the valve plate are advantageously arranged so that they do not overlap in the closed state of the gas valve. If, moreover, sealing regions, which interact for sealing the flow holes, are advantageously formed between the holes of the valve plate and of the valve head, then the gas valve achieves a high level of sealing with only minimal leakage flows.

In a further advantageous embodiment, the valve head is at least in the main of circular disk-like design and the holes in the valve head are arranged in hole circles which are formed around the center of the valve head. The same arrangement of holes can also be provided in the valve plate, wherein in this case also the hole circles are formed around the center of an essentially circular disk-like valve plate. This arrangement of the holes can be produced in a simple manner on corresponding drilling machines and allows a dense arrangement of the holes.

In a further advantageous embodiment, the holes in the valve head do not all have the same diameter. Similarly, the flow holes in the valve plate may not all have the same diameter. As a result of the different hole diameters, on the one hand a closer packing of the holes can be achieved with sufficiently stable ribs between the holes at the same time. On the other hand, an optimum adjustment of the flow downstream of the gas valve can consequently be achieved.

The holes which are formed in the valve head and/or in the valve plate have a circular diameter so that they can be produced by means of a simple drilling process.

### BRIEF DESCRIPTION OF THE DRAWINGS

Shown in the drawing is a gas valve according to the invention. In the drawing

FIG. 1 shows in longitudinal section a gas valve known from the prior art, wherein only the essential regions are shown,

FIG. 2 shows a cross section through the valve head of the gas valve shown in FIG. 1, wherein only one half of the valve head is shown,

FIG. 3 shows in longitudinal section an exemplary embodiment of the gas valve according to the invention, wherein in this also only the essential regions are shown, and

FIG. 4 and FIG. 5 show in a plan view valve heads according to the invention of the gas valve shown in FIG. 3.

### DETAILED DESCRIPTION

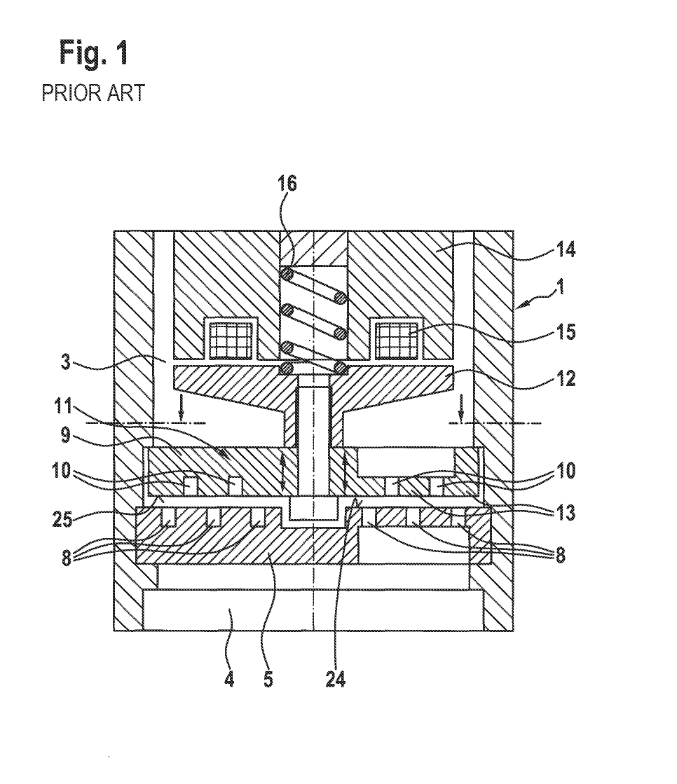

Shown in FIG. 1 is a gas valve which is known from the prior art. The gas valve has a housing 1 in which is formed a gas space 3. The gas space 3 is fed with gas under a specified feed pressure which, for example, serves for injection in an induction tract of a heat engine. In the housing 1, a valve plate 5 is arranged in a fixed manner. The valve plate 5 is in the main of disk-like design and has an end face 24 which faces the gas space 3. Formed in the valve plate 5 is a row of slots 8 through which the gaseous fuel flows and makes its way into an outflow opening 4 of the housing 1 through these slots 8. The outflow opening 4 opens in this case into an induction tract of a heat engine, for example.

Arranged in the gas space 3, opposite the valve plate 5, in a longitudinally movable manner is a valve head 9 which is also in the main of disk-like design and has a flat end face 25 facing the valve plate 5. The valve head 9 is connected to a solenoid armature 12 upon which acts the force of a closing spring 16 so that the solenoid armature 12 together with the valve head 9 are pressed against the valve plate 5 by the force of the closing spring 16. The closing spring 16 is arranged in the housing 1 in a manner encompassing a solenoid core 14 in which is arranged in turn a solenoid 15. By energizing the solenoid 15, a pulling force is exerted upon the solenoid armature 12, pulling the solenoid armature 12 against the force of the closing spring 16 in the direction of the solenoid 15, as a result of which the valve head 9 is lifted from the valve plate 5.

For the throughflow of gas from the gas space 3 to the outflow opening 4, inflow slots 10 are formed in the valve head 9 through which the gas can flow with the gas valve open, that is to say when the valve head 9 is at a distance from the valve plate 5, and flows through the space between the valve head and the valve plate 5 towards the slots 8 and flows through these to the outflow opening 4. For closing the gas valve, the energizing of the solenoid 15 is correspondingly deactivated so that the closing spring 16 presses the solenoid armature 12, and consequently also the valve head 9, onto the valve plate 5 for the reverse position. The slots 8 and the inflow slots 10 in the valve plate 5 and in the valve head 9 respectively are arranged in this case so that they do not overlap when the valve head 9 rests on the valve plate 5. The regions between the slots 8 or between the inflow slots 10 consequently form sealing regions so that the gas valve in the closed state is sealed with the exception of tolerable residual leakage.

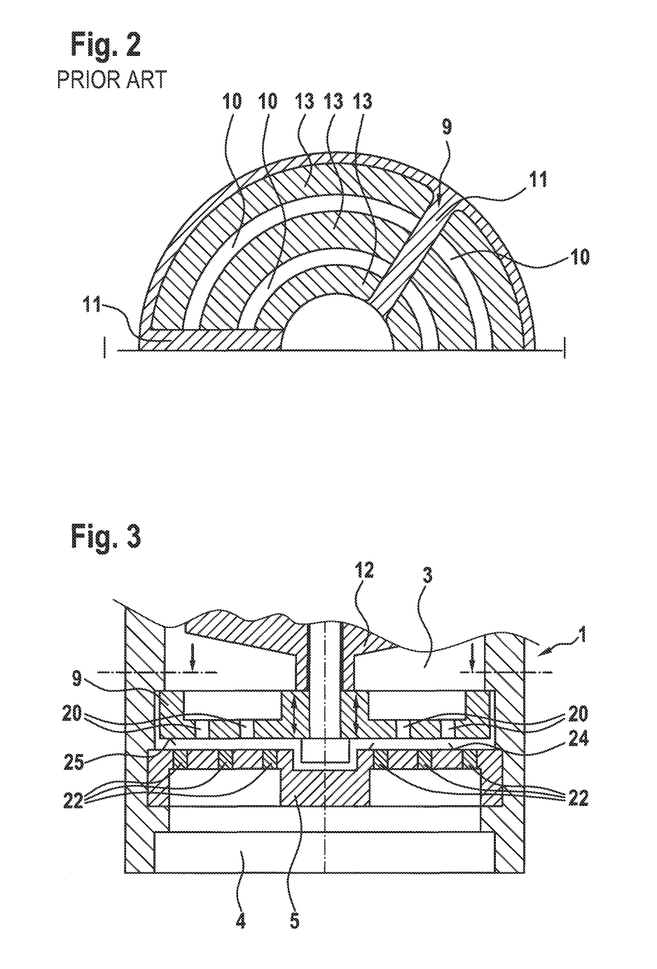

The more detailed construction of the valve head 9 is shown in FIG. 2, wherein the valve head 9 here is shown in plan view and only one half is shown. The line I-I of FIG. 2 corresponds in this case to the sectional plane of FIG. 1. The valve head 9 has a row of concentric rings 13 between which the inlet slots 10 are formed as also concentrically extending holes. The rings 13 are held together by means of ribs 11 which extend outwards in the radial direction from the center of the valve head 9. This construction of the valve head 9 also corresponds in the main to the construction of the valve plate 5, wherein the inflow slots 10 in the valve head 9 are arranged in relation to the slots 8 of the valve plate 5 so that they do not overlap in the closed state of the gas valve.

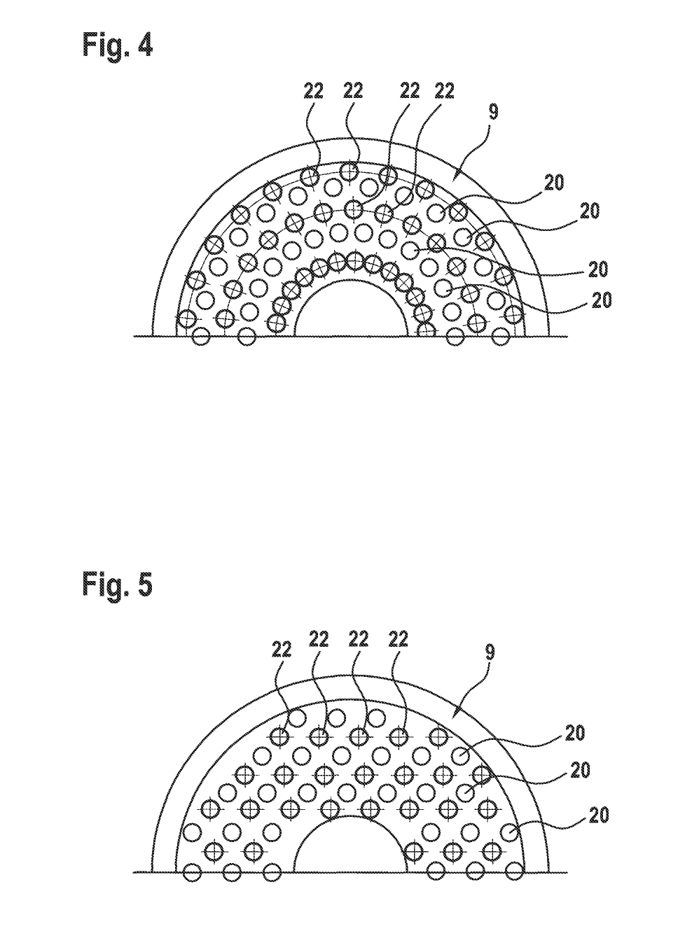

Shown in longitudinal section in FIG. 3 is an exemplary embodiment of a gas valve according to the invention, wherein the view corresponds to that in FIG. 1. The same designations have been correspondingly used for the same components. The valve head 9, in contrast to the known gas valve of FIG. 1, has holes 20 which have a circular cross section. FIG. 4 shows a plan view of the valve head 9 for this purpose, wherein only one half of the valve head 9 is shown. The valve plate 5 also has flow holes 22 which also have a circular cross section. In FIG. 4, these flow holes 22 are also shown as a projection since these are concealed by the valve head 9 in this view. The holes 20 in the valve head 9 and the flow holes 22 in the valve plate 5 are arranged in this case so that they do not overlap in the closed state of the gas valve, as is also made clear in FIG. 4. The holes 20 in the valve head 9 in this exemplary embodiment are arranged in concentric circles in the same way as the flow holes 22 in the valve plate 5 and are arranged around the center of the essentially annular disk-like valve head 9. Between the holes 20 or the flow holes 22 sealing regions are formed on the valve head 9 or on the valve plate 5 so that sealing between the holes 20 and the flow holes 22 is ensured when the gas valve is closed, that is to say when the valve head 9 rests on the valve plate 5.

The holes 20 and the flow holes 22 have a circular cross section. Alternatively to the view shown in FIG. 4, it can also be provided that the holes 20 and flow holes 22 in the valve plate 5 and in the valve head 9 respectively do not all have the same diameter in order to achieve an optimum utilization of the available constructional space. Therefore, gaps between holes with a relatively large diameter can be filled by holes with a smaller diameter without the rib width between the individual holes leading to an instability of the valve head 9 or of the valve plate 5.

Shown in FIG. 5 is a further exemplary embodiment of a valve head 9 according to the invention, wherein in this case the holes 20 and the flow holes 22 no longer lie on concentric circles but are arranged in a rectangular pattern. Depending on the number of the desired holes and the required sealing, this arrangement of the holes 20 and flow holes 22 can be advantageous. It is also possible to arrange the holes 20 and the flow holes 22 in a triangular or hexagonal pattern, for example, according to which overall cross section of the openings is required and which rib widths have to be provided.

The holes 20 and the flow holes 22 are constructed as vertical holes, i.e. the holes are arranged perpendicularly to the end face 24 of the valve plate 5 and to the end face 25 of the valve head 9 respectively. As a result, the maximum possible number of holes can be arranged in the valve plate 5 and in the valve head 9.

What is claimed is:

1. A gas valve for the fuel supply of heat engines, with a housing (1) and with a valve plate (5) in which are formed flow holes (22) for the passage of the gas flow which is to be controlled, and with a valve head (9) which is arranged in a longitudinally movable manner in the gas valve and which interacts with the valve plate (5) for opening and closing the flow holes (22), wherein holes (20) for the gas flow which is to be controlled are formed in the valve head (9) and wherein the flow holes (22) in the valve plate (5) have a circular cross section.

2. The gas valve according to claim 1, characterized in that the valve plate (5) is at least in the main of disk-like design and has an end face (24) and the holes (22) are orientated perpendicularly to said end face (24) of the valve plate (5).

3. The gas valve according to claim 1, characterized in that the valve plate (5) is clamped in a fixed manner inside the housing (1).

4. The gas valve according to one of claim 1, characterized in that the holes (20) in the valve head (9) are formed as holes with a circular cross section.

5. The gas valve according to claim 4, characterized in that the holes (20) of the valve head (9) and the flow holes (22) of the valve plate (5) do not overlap in a closed state of the gas valve.

6. The gas valve according to claim 5, characterized in that the valve head (9) is in the main of disk-like design and has an end face (25) which faces the valve plate (5), and sealing regions, which interact for sealing of the gas flow, are formed between the holes (20) on the end face (25) of the valve head (9) and/or between the flow holes (22) of the valve plate (5).

7. The gas valve according to claim 4, characterized in that the valve head (9) is at least in the main of circular disk-like design and the holes (20) in the valve head (9) are arranged in hole circles which extend around the center of the valve head (9).

8. The gas valve according to claim 4, characterized in that the valve plate (5) is at least in the main of circular disk-like design and the flow holes (22) in the valve plate (5) are in hole circles which are formed around the center of the at least in the main circular disk-like valve plate (5).

9. The gas valve according to claim 1, characterized in that the holes (20) in the valve head (9) do not all have the same diameter and/or the flow holes (22) in the valve plate (5) do not all have the same diameter.

10. The gas valve according to claim 2, characterized in that the valve plate (5) is clamped in a fixed manner inside the housing (1).

11. The gas valve according to one of claim 10, characterized in that the holes (20) in the valve head (9) are formed as holes with a circular cross section.

12. The gas valve according to claim 11, characterized in that the holes (20) of the valve head (9) and the flow holes (22) of the valve plate (5) do not overlap in a closed state of the gas valve.

13. The gas valve according to claim 12, characterized in that the valve head (9) is in the main of disk-like design and has an end face (25) which faces the valve plate (5), and sealing regions, which interact for sealing of the gas flow, are formed between the holes (20) on the end face (25) of the valve head (9) and/or between the flow holes (22) of the valve plate (5).

14. The gas valve according to claim 13, characterized in that the valve head (9) is at least in the main of circular disk-like design and the holes (20) in the valve head (9) are arranged in hole circles which extend around the center of the valve head (9).

15. The gas valve according to claim 13, characterized in that the valve plate (5) is at least in the main of circular disk-like design and the flow holes (22) in the valve plate (5) are in hole circles which are formed around the center of the at least in the main circular disk-like valve plate (5).

16. The gas valve according to claim 14, characterized in that the holes (20) in the valve head (9) do not all have the same diameter and/or the flow holes (22) in the valve plate (5) do not all have the same diameter.

17. The gas valve according to claim 14, characterized in that the holes (20) in the valve head (9) do not all have the same diameter and/or the flow holes (22) in the valve plate (5) do not all have the same diameter.
